(19) United States
(12) Patent Application Publication
(10) Pub. No.: US 2024/0322195 A1
(43) Pub. Date: Sep. 26, 2024

(54) FUEL CELL SYSTEM CONFIGURED TO OPERATE IN COLD CONDITIONS AND METHOD OF OPERATING THE SAME

(71) Applicant: BLOOM ENERGY CORPORATION, San Jose, CA (US)

(72) Inventors: Prasad PMSVVSV, Sunnyvale, CA (US); Samuel JUDAY, Sunnyvale, CA (US); Lorenzo PENNA, San Jose, CA (US)

(21) Appl. No.: 18/601,757

(22) Filed: Mar. 11, 2024

Related U.S. Application Data
(60) Provisional application No. 63/491,110, filed on Mar. 20, 2023.

(51) Int. Cl. H01M 8/04007; H01M 8/0432; H01M 8/04746; H01M 8/24

(52) U.S. Cl. CPC H01M 8/04052; H01M 8/04037; H01M 8/04373; H01M 8/04776; H01M 8/24

(57) ABSTRACT

A fuel cell system includes a power module housing including a hotbox cabinet and an auxiliary cabinet, a hotbox disposed in the hotbox cabinet and including a stack of fuel cells, electronic components disposed in the auxiliary cabinet, a system blower configured to provide air into the power module housing, a hotbox air inlet conduit fluidly connecting the system blower to the hotbox, a heat exchanger configured to preheat air in the hotbox air inlet conduit by extracting heat from cathode exhaust output from the hotbox, and a cathode exhaust outlet conduit fluidly connecting a cathode exhaust outlet of the hotbox to the heat exchanger.

### FIELD

Aspects of the present invention relate to fuel cell systems, and more particularly, to fuel cell systems configured to operate in cold conditions.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, provided is a fuel cell system comprising: a power module housing comprising a hotbox cabinet and an auxiliary cabinet; a hotbox disposed in the hotbox cabinet and comprising a stack of fuel cells; electronic components disposed in the auxiliary cabinet; a system blower configured to provide air into the power module housing; a hotbox air inlet conduit fluidly connecting the system blower to the hotbox; a heat exchanger configured to preheat air in the hotbox air inlet conduit by extracting heat from cathode exhaust output from the hotbox; and a cathode exhaust outlet conduit fluidly connecting a cathode exhaust outlet of the hotbox to the heat exchanger.

According to various embodiments, provided is a fuel cell system comprising: a power module housing comprising a hotbox cabinet and an auxiliary cabinet; a hotbox disposed in the hotbox cabinet and comprising a stack of fuel cells; electronic components disposed in the auxiliary cabinet; a system blower configured to provide air into the power module housing; a hotbox air inlet conduit fluidly connecting the system blower to the hotbox; a heat exchanger configured to preheat air in the hotbox air inlet conduit by extracting heat from cathode exhaust output from the hotbox; a cathode exhaust outlet conduit fluidly connecting a cathode exhaust outlet of the hotbox to the heat exchanger; a supplemental heater configured to preheat air in the air inlet conduit; and a bypass conduit fluidly connected to the hotbox air inlet conduit, wherein the bypass conduit bypasses the heat exchanger and the auxiliary heater.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell system, according to various embodiments of the present disclosure.

FIG. 2A is a sectional view showing components of the hot box of the system of FIG. 1, FIG. 2B shows an enlarged portion of the system of FIG. 2A, FIG. 2C is a three dimensional cut-away view of a central column of the system of FIG. 2A, and FIG. 2D is a perspective view of an anode hub structure disposed below the central column of the system of FIG. 2A, according to various embodiments of the present disclosure.

FIGS. 3A-3C are sectional views showing fuel and air flow through the central column of the system of FIG. 2A, according to various embodiments of the present disclosure.

FIGS. 4, 5, 6, 7, 8 and 9 are schematic views of fuel cell systems, according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

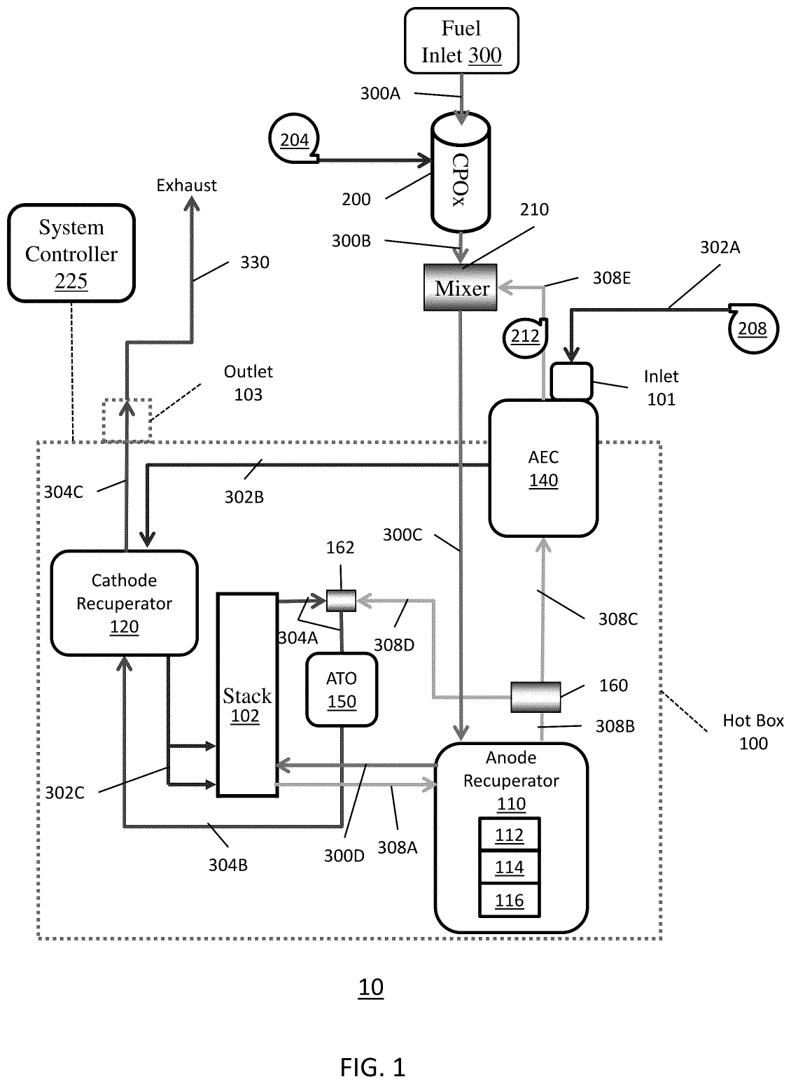

FIG. 1 is a schematic representation of a SOFC system 10, according to various embodiments of the present disclosure. Referring to FIG. 1, the system 10 includes a hotbox 100 and various components disposed therein or adjacent thereto. The hot box 100 may contain fuel cell stacks 102, such as a solid oxide fuel cell stacks containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other in a plurality of columns.

The hot box 100 may also contain an anode recuperator heat exchanger 110, a cathode recuperator heat exchanger 120, an anode tail gas oxidizer (ATO) 150, an anode exhaust cooler heat exchanger 140, a splitter 160, and a vortex generator 162. The system 10 may also include a catalytic partial oxidation (CPOx) reactor 200, a mixer 210, a CPOx blower 204 (e.g., air blower), a system blower 208 (e.g., air blower), and an anode recycle blower 212, which may be disposed outside of the hotbox 100. However, the present disclosure is not limited to any particular location for each of the components with respect to the hotbox 100.

The CPOx reactor 200 receives a fuel inlet stream from a fuel inlet 300, through fuel conduit 300A. The fuel inlet 300 may be a fuel tank or a utility natural gas line including a valve to control an amount of fuel provided to the CPOx reactor 200. The CPOx blower 204 may provide air to the CPOx reactor 202 during system start-up. The fuel and/or air may be provided to the mixer 210 by fuel conduit 300B. Fuel flows from the mixer 210 to the anode recuperator 110 through fuel conduit 300C. The fuel is heated in the anode recuperator 110 by a portion of the fuel exhaust and the fuel then flows from the anode recuperator 110 to the stack 102 through fuel conduit 300D.

The system blower 208 may be configured to provide an air stream (e.g., air inlet stream) to an air inlet 101 of the anode exhaust cooler 140 through hotbox air inlet conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C.

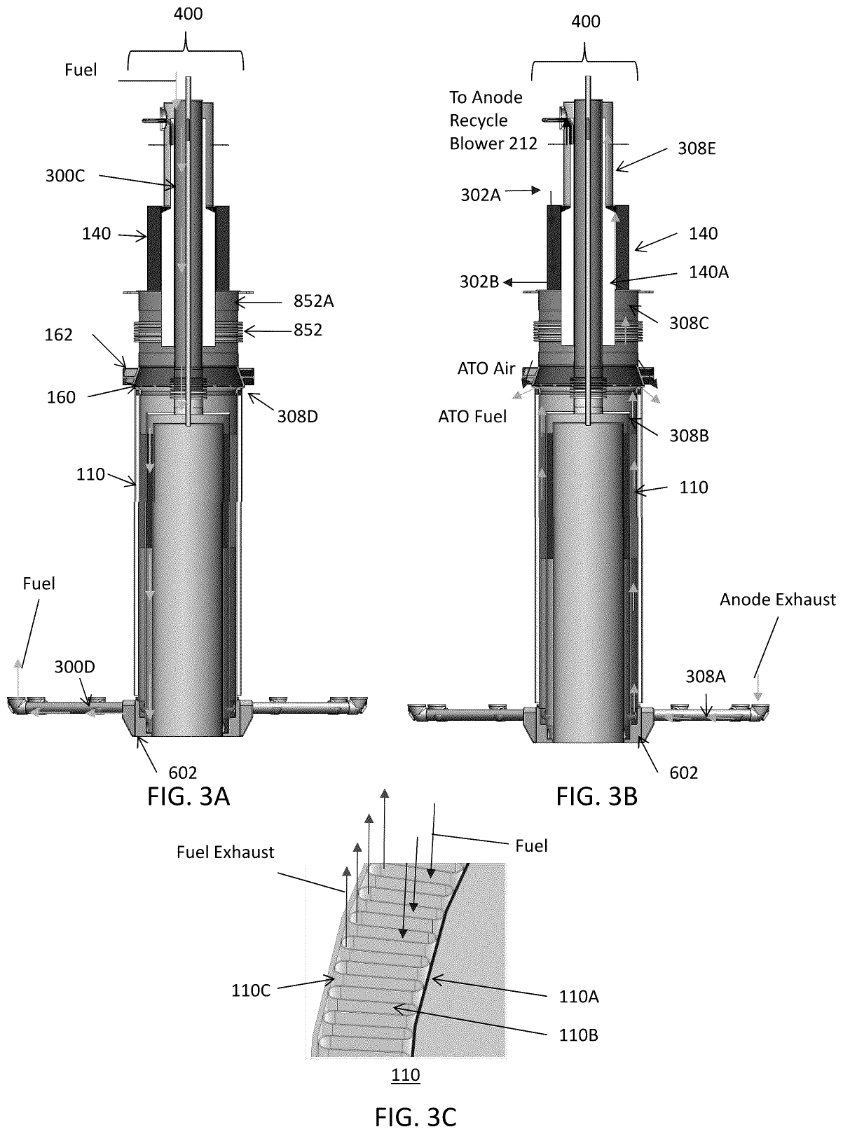

An anode exhaust stream (e.g., the fuel exhaust stream described below with respect to FIGS. 3A-3C) generated in the stack 102 is provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 160 by anode exhaust conduit 308B. A first portion of the anode exhaust may be provided from the splitter 160 to the anode exhaust cooler 140 through the anode exhaust conduit 308C. A second portion of the anode exhaust is provided from the splitter 160 to the ATO 150 through the anode exhaust conduit 308D. The first portion of the anode exhaust heats the air inlet stream in the anode exhaust cooler 140 and may then be provided from the anode exhaust cooler 140 to the mixer 210 through the anode exhaust conduit 308E. The anode recycle blower 212 may be configured to move anode exhaust though anode exhaust conduit 308E.

Cathode exhaust generated in the stack 102 flows to the ATO 150 through cathode exhaust conduit 304A. The vortex generator 162 may be disposed in the exhaust conduit 304A and may be configured to swirl the cathode exhaust. The anode exhaust conduit 308D may be fluidly connected to the vortex generator 162 or to the cathode exhaust conduit 304A or the ATO 150 downstream of the vortex generator 162. The swirled cathode exhaust may mix with the second portion of the anode exhaust provided by the splitter 160 before being provided to the ATO 150. The mixture may be oxidized in the ATO 150 to generate an ATO exhaust. The ATO exhaust flows from the ATO 150 to the cathode recuperator 120 through the cathode exhaust conduit 304B. Exhaust flows from the cathode recuperator 120 to a cathode exhaust outlet 103 of the hotbox 100 through cathode exhaust conduit 304C. A cathode exhaust outlet conduit 330 may be fluidly connected to the cathode exhaust outlet 103.

An optional water injector (not shown) may be provided on the anode exhaust conduit 308C. The water injector may comprise a nozzle or pipe connected to a water source (e.g., water tank or municipal water supply pipe). The injector injects the water into the anode exhaust stream, where the water is vaporized and converted to steam. Alternatively or in addition, a steam generator (not shown in FIG. 1) may be located in the hot box to provide steam into the mixer 210. The steam generator may comprise one or more water pipes located in the path of the cathode exhaust stream, such that the cathode exhaust stream exiting the cathode recuperator 120 via conduit 304C vaporizes the water in the one or more water pipes.

The system 10 may further a system controller 225 configured to control various elements of the system 10. The controller 225 may include a central processing unit configured to execute stored instructions. For example, the controller 225 may be configured to control fuel and/or air flow through the system 10, according to fuel composition data.

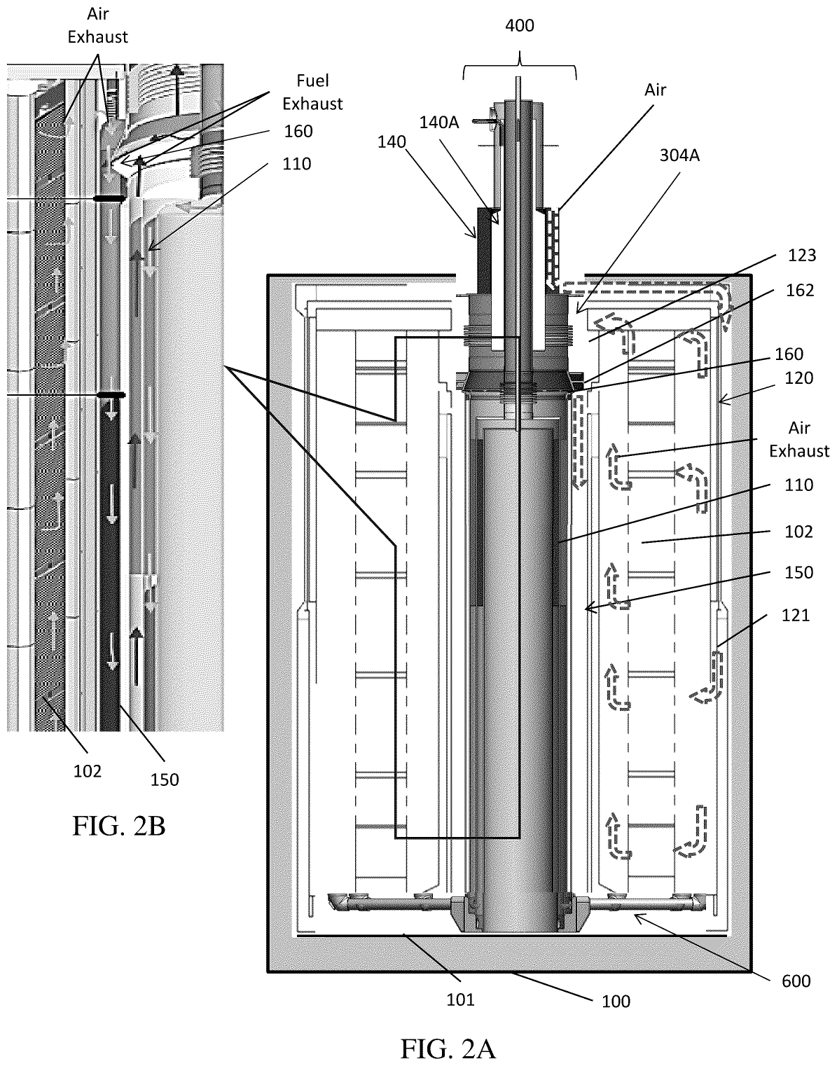

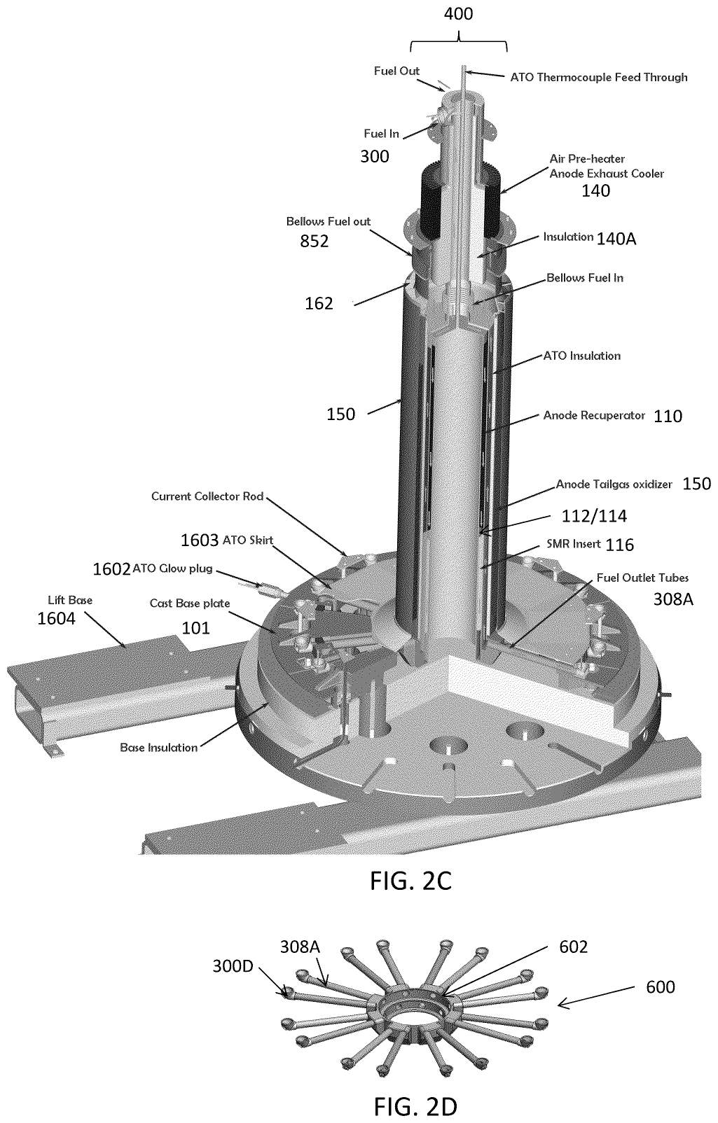

FIG. 2A is a sectional view showing components of the hot box 100 of the system 10 of FIG. 1, and FIG. 2B shows an enlarged portion of FIG. 2A. FIG. 2C is a three-dimensional cut-away view of a central column 400 of the system 10, according to various embodiments of the present disclosure, and FIG. 2D is a perspective view of an anode hub structure 600 disposed in a hot box base 101 on which the column 400 may be disposed.

Referring to FIGS. 2A-2D, the fuel cell stacks 102 may be disposed around the central column 400 in the hot box 100. For example, the stacks 102 may be disposed in a ring configuration around the central column 400 and may be positioned on the hot box base 101. The column 400 may include the anode recuperator 110, the ATO 150, and the anode exhaust cooler 140. In particular, the anode recuperator 110 is disposed radially inward of the ATO 150, and the anode exhaust cooler 140 is mounted over the anode recuperator 110 and the ATO 150. In one embodiment, an oxidation catalyst 112 and/or the hydrogenation catalyst 114 may be located in the anode recuperator 110. A reforming catalyst 116 may also be located at the bottom of the anode recuperator 110 as a steam methane reformation (SMR) insert. The ATO 150 may include an oxidation catalyst.

The anode hub structure 600 may be positioned under the anode recuperator 110 and ATO 150 and over the hot box base 101. The anode hub structure 600 is covered by an ATO skirt 1603. The vortex generator 162 and fuel exhaust splitter 160 are located over the anode recuperator 110 and ATO 150 and below the anode exhaust cooler 140. An ATO glow plug 1602, which initiates the oxidation of the stack fuel exhaust in the ATO during startup, may be located near the bottom of the ATO 150.

The anode hub structure 600 is used to distribute fuel evenly from the central column to fuel cell stacks 102 disposed around the central column 400. The anode flow hub structure 600 includes a grooved cast base 602 and a “spider” hub of fuel inlet conduits 300D and outlet conduits 308A. Each pair of conduits 300D, 308A connects to a fuel cell stack 102. Anode side cylinders (e.g., anode recuperator 110 inner and outer cylinders and ATO outer cylinder 502) are then welded or brazed into the grooves in the base 602, creating a uniform volume cross section for flow distribution as discussed below.

A lift base 1604 is located under the hot box base 101, as illustrated in FIG. 2C. In an embodiment, the lift base 1604 includes two hollow arms with which the forks of a fork lift can be inserted to lift and move the system, such as to remove the system from a cabinet (not shown) for repair or servicing.

As shown by the arrows in FIGS. 2A and 2B, air enters the top of the hot box 100 and flows through the anode exhaust cooler 140 where it is heated by anode exhaust and then flows into the cathode recuperator 120 where it is heated by ATO exhaust (not shown) from the ATO 150. The heated air then flows inside the cathode recuperator 120 through a first vent or opening 121. The air then flows through the stacks 102 and reacts with fuel (i.e., fuel inlet stream) provided from the anode hub structure 600. Air exhaust flows from the stacks 102, through a second vent or opening 123. The air exhaust then passes through vanes of the vortex generator 162 and is swirled before entering the ATO 150.

The splitter 160 may direct the second portion of the fuel exhaust exiting the top of the anode recuperator 100 through openings (e.g., slits) in the splitter into the swirled air exhaust (e.g., in the vortex generator 162 or downstream of the vortex generator in the cathode exhaust conduit 304A or in the ATO 150). As illustrated in FIG. 2A, the second portion of the fuel exhaust and air exhaust may be mixed before entering the ATO 150.

FIGS. 3A and 3B are side cross-sectional views showing flow distribution through the central column 400, and 3C is top cross-sectional view taken through the anode recuperator 110. Referring to FIGS. 2A, 2B, 3A, and 3C, the anode recuperator 110 includes an inner cylinder 110A, a corrugated plate 110B, and an outer cylinder 110C. Fuel from fuel conduit 300C enters the top of the central column 400. The fuel then bypasses the anode exhaust cooler 140 by flowing through its hollow core and then flows through the anode recuperator 110, between the outer cylinder 110C and the and the corrugated plate 110B. The fuel then flows through the hub base 602 and conduits 300D of the anode hub structure 600 shown in FIG. 3B, to the stacks 102.

Referring to FIGS. 2A, 2B, 2C, 3A, and 3B, the fuel exhaust flows from the stacks 102 through conduits 308A into the hub base 602, and from the hub base 602 through the anode recuperator 110, between in inner cylinder 110A and the corrugated plate 110B, and through conduit 308B into the splitter 160. The first portion of the fuel exhaust flows from the splitter 160 to the anode exhaust cooler 140 through conduit 308C, while the second portion flows from the splitter 160 to the ATO 150 through conduit 308D, as shown in FIG. 1. Anode exhaust cooler inner core insulation 140A may be located between the fuel conduit 300C and bellows 852/supporting cylinder 852A located between the anode exhaust cooler 140 and the vortex generator 162, as shown in FIG. 3A. This insulation minimizes heat transfer and loss from the first portion of the anode exhaust stream in conduit 308C on the way to the anode exhaust cooler 140. Insulation 140A may also be located between conduit 300C and the anode exhaust cooler 140 to avoid heat transfer between the fuel inlet stream in conduit 300C and the streams in the anode exhaust cooler 140. In other embodiments, insulation 140A may be omitted from inside the cylindrical anode exhaust cooler 140.

FIG. 3B also shows air flowing from the air conduit 302A to the anode exhaust cooler 140 (where it is heated by the first portion of the anode exhaust) and then from the anode exhaust cooler 140 through conduit 302B to the cathode recuperator 120. The first portion of the anode exhaust is cooled in the anode exhaust cooler 140 by the air flowing through the anode exhaust cooler 140. The cooled first portion of the anode exhaust is then provided from the anode exhaust cooler 140 to the anode recycle blower 212 shown in FIG. 1.

As will be described in more detail below and as shown in FIGS. 2A and 3B, the anode exhaust exits the anode recuperator 110 and is provided into splitter 160 through conduit 308B. The splitter 160 splits the anode exhaust into first and second anode exhaust portions (i.e., streams). The first stream is provided into the anode exhaust cooler 140 through conduit 308C. The second stream is provided to the ATO 150 through conduit 308D.

The relative amounts of anode exhaust provided to the ATO 150 and the anode exhaust cooler 140 are controlled by the anode recycle blower 212. The higher the blower 212 speed, the larger portion of the anode exhaust is provided into conduit 308C and a smaller portion of the anode exhaust is provided to the ATO 150 via conduit 308D, and vice-versa.

The anode exhaust provided to the ATO 150 is not cooled in the anode exhaust cooler 140. This allows higher temperature anode exhaust to be provided into the ATO 150 than if the anode exhaust were provided after flowing through the anode exhaust cooler 140. For example, the anode exhaust provided into the ATO 150 from the splitter 160 may have a temperature of above 350° C., such as from about 350 to about 500° C., for example, from about 375 to about 425° C., or from about 390 to about 410° C. Furthermore, since a smaller amount of anode exhaust is provided into the anode exhaust cooler 140 (e.g., not 100% of the anode exhaust is provided into the anode exhaust cooler due to the splitting of the anode exhaust in splitter 160), the heat exchange area of the anode exhaust cooler 140 may be reduced. The anode exhaust provided to the ATO 150 may be oxidized by the stack cathode (i.e., air) exhaust and provided to the cathode recuperator 120 through the cathode exhaust conduit 304B.

### Cold Weather Configurations

Fuel cell system are typically rated for operation in ambient air temperatures of about −20° C. or greater. Designing fuel cell systems, such as solid oxide fuel cell (SOFC) systems to work in extreme cold weather conditions (e.g., ambient temperatures less than negative 20° C.) is a challenging task both for outdoor rated as well as indoor rated systems, and particularly for systems that use high volumes of air flow. In some systems, it may not be possible to add localized heaters to certain components, for example motor bearings, and utilizing components designed for extremely low temperatures may be cost and/or size prohibitive. Conventionally, warming incoming air using one or more heaters to a desired temperature range may require a large amount of energy, which decreases the overall efficiency of the system.

In view of such problems, various embodiments provide fuel cell systems that utilize heat generated by exothermic fuel cell reactions to heat incoming ambient air to a desired operating temperature. Various embodiments provide improved efficiency cold weather operation, as compared to conventional systems. These embodiments provide modifications and components to the fuel cell systems for operation in cold conditions, such as cold weather conditions in ambient air temperatures of less than −20° C., such as −21° C. to −40° C.

In cold weather conditions, the ambient air provided to the anode exhaust cooler 140 may excessively cool the anode exhaust stream, which may cause undesirable water condensation in the anode exhaust stream. Specifically, in the embodiments of the present disclosure, the temperature of the anode exhaust stream exiting the anode exhaust cooler 140 is maintained above about 100° C., such as a temperature of above about 105° C. For example, the anode exhaust may be output from the anode exhaust cooler 140 at a temperature ranging from about 110° C. to about 180° C., such as from about 110° C. to about 120° C., when ambient air temperatures are below −20° C. Therefore, water vapor in the anode exhaust is maintained above the water boiling temperature to prevent water condensation in the anode exhaust. Furthermore, the anode exhaust may be maintained below the maximum operating temperature rating of the anode exhaust blower 212 to prevent damage to the anode exhaust blower 212. For example, if the anode exhaust blower is rated for a maximum operating temperature of 200° C., then the temperature of the anode exhaust entering the anode exhaust blower 212 from the anode exhaust cooler 140 may be maintained at 180° C. or less. Therefore, water condensation (and potential water freezing in the pipes at extreme cold temperatures) is avoided without damaging the anode exhaust blower 212.

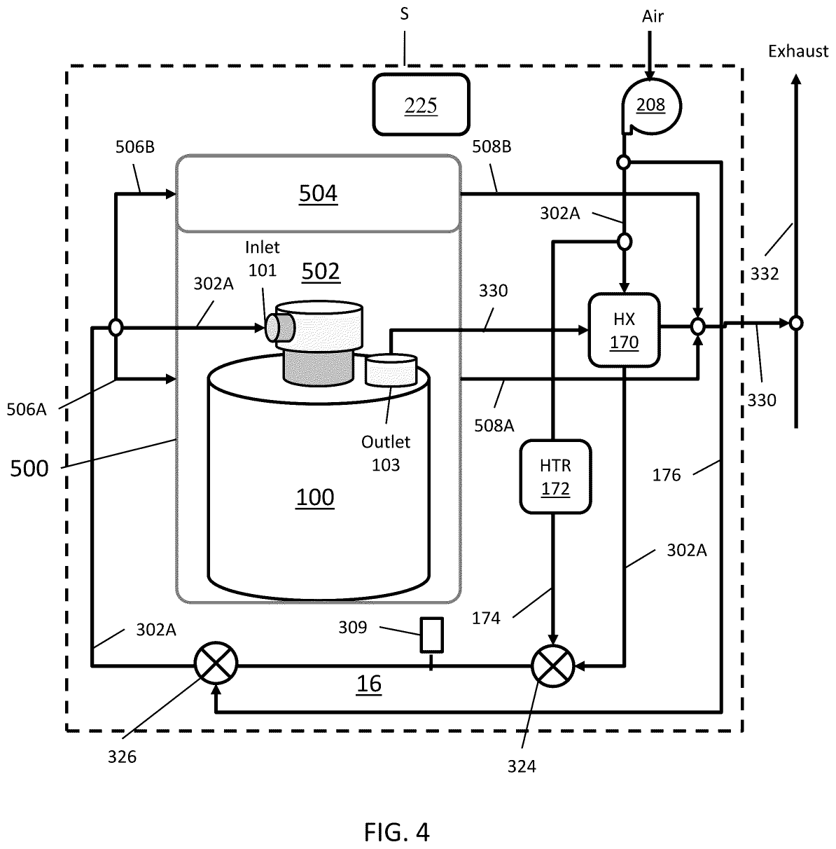

FIG. 4 is a schematic view of a fuel cell system 16, according to another embodiment of the present disclosure. The system 16 may be similar to the system 10. As such, only the differences therebetween will be discussed in detail.

Referring to FIG. 4, the system 16 may include a power module housing 500 that may be divided into a hotbox cabinet 502 and an auxiliary cabinet 504. The system 16 may optionally be disposed in a system enclosure S, such as a building or system housing.

The hotbox 100 may be disposed in the hotbox cabinet 502, and system electronics, such as the controller 225, power converters (e.g., DC/DC converters), etc., may be disposed in the auxiliary cabinet 504. While one housing 500 is shown, the system 16 may include multiple housings 500, which may be aligned in rows within the system enclosure and/or on a common base, with each housing 500 including a hotbox 100 and other auxiliary system components.

The system 16 may include a heater 172, a heater valve 324, a heater conduit 174, and the cathode exhaust outlet conduit 330. The heat exchanger 170 may be configured to preheat air provided from the air blower 208 to the hotbox 100 via hotbox air inlet conduit 302A, by extracting heat from cathode exhaust stream output from the hotbox 100 via the cathode exhaust outlet 103 and the cathode exhaust outlet conduit 330, as described above with respect to FIG. 1 and system 10. In some embodiments, all or substantially all of the cathode exhaust output from the hotbox 100 may be provided to the heat exchanger 170. In some embodiments, the heat exchanger 170 may be configured to preheat the ambient air to a temperature of at least −20° C. Accordingly, the heat exchanger 170 may allow for the system 16 to operate using extremely cold ambient air, such as ambient air having a temperature of less than −20° C.

The heater 172 may be any suitable type of heater, such as a gas or electric heater. The heater 172 may be configured to provide supplemental heating to incoming air, for example, if the amount and/or temperature of the cathode exhaust stream supplied to the heat exchanger 170 is insufficient to heat the air inlet stream to a desired temperature, such as during system startup or shutdown, the heater 172 may be used to provide heating that would be provided by the cathode exhaust during steady-state operation. When the heater 172 is an electrical heater, then the heater 172 may be powered by two redundant sources i.e., utility grid and fuel cell system. The system 16 may include an electrical transfer switch to switch between the two power sources.

The heater valve 324 may control air flow through the heater 172 and the heater conduit 174. The heater valve 324 may be an on/off valve or a proportional valve. In some embodiments, the controller 225 may be configured to control and/or be operatively connected to components within one or more power module housings 500 and/or components disposed outside of the power module housings 500, such as valves, sensors, etc. As such, the controller 225 may be disposed inside the system enclosure S and outside of the power module housing 500. However, the present disclosure is not limited to any particular controller location. The controller 225 may control the heater valve 324 and or the heater 172, to provide supplemental heating, based on a temperature of air in the air conduit 302A, which may be detected by a temperature sensor 309 disposed on the air conduit 302A, downstream of the heat exchanger 170 and/or the heater valve 324. In an alternative embodiment, the heater valve 324 may be located upstream of heat exchanger 170 and heater 172.

The system 16 may optionally include a bypass valve 326 and a preheating bypass conduit 176. The preheating bypass conduit 176 may be fluidly connected to the air conduit 302A, upstream and downstream from the heat exchanger 170 and the heater valve 324. The bypass valve 326 may be configured to control the air inlet stream flow through the preheating bypass conduit 176, in order to selectively bypass the heat exchanger 170 and/or the heater 172. In an alternative embodiment, the bypass valve 326 may be located upstream of heat exchanger 170 and heater 172.

For example, if the controller 225 determines that an amount and/or temperature of the cathode exhaust stream supplied to the heat exchanger 170 is insufficient to heat the air inlet stream to a desired temperature, then the controller turns on the heater 172 and opens the heater valve 324 and closes the bypass valve 326 (to close off the preheating bypass conduit 176) to allow at least a portion of the air inlet stream to be provided into the heater conduit 174 to be heated in the heater 172 before being provided into the air conduit 302. The portion of the air inlet stream provided to the heater 172 may bypass the heat exchanger 170. If the controller 225 determines that an amount and/or temperature of the cathode exhaust stream supplied to the heat exchanger 170 is sufficient to heat the air inlet stream to a desired temperature, then the heater valve 324 is closed. Furthermore, if the air inlet stream temperature is determined by the controller 225 to be higher than desired, then the controller 225 opens the bypass valve 326 and closes the heater valve 324 to provide at least a portion of the (or the entire) air inlet stream into the preheating bypass conduit 176 to bypass the heat exchanger 170 and the heater 172.

The system 16 may also include a hotbox cabinet air inlet conduit 506A and/or an auxiliary cabinet air inlet conduit 506B fluidly connecting and configured to provide air from the air conduit 302A to the hotbox cabinet 502 and/or the auxiliary cabinet 504, respectively. The system 16 may include a hotbox cabinet air outlet conduit 508A and/or an auxiliary cabinet air outlet conduit 508B configured to respectively receive air output from the hotbox cabinet 502 and the auxiliary cabinet 504. The air outlet conduits 508A, 508B may be fluidly connected to the system exhaust conduit 332, in some embodiments. Accordingly, warm air may be output from the hotbox cabinet 502 to the system exhaust conduit 332 by the air outlet conduit 508A, and warm air may be output from the auxiliary cabinet 504 to the system exhaust conduit 332 by the air outlet conduit 508B. In some embodiments, air from multiple housings 500 may be provided to the system exhaust conduit 332.

Although not shown, in some embodiments, the air inlet conduits 506A, 506B may be fluidly connected to the air valve 326, such that air may be provided to the hotbox cabinet 502 and/or the auxiliary cabinet 504 from the preheating bypass conduit 176 at a lower temperature than the air provided to the hotbox 100.

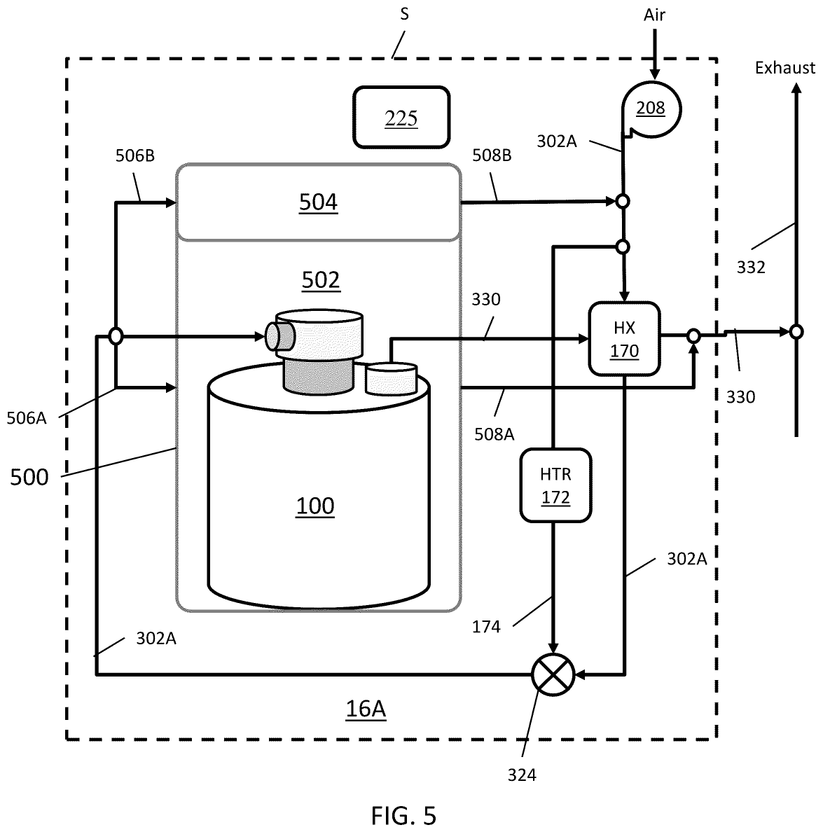

FIG. 5 is a schematic view of a fuel cell system 16A, according to various embodiments of the present disclosure. The system 16A may be similar to system 16. As such, only the differences therebetween will be discussed in detail.

Referring to FIG. 5, in system 16A, the air outlet conduit 508B may fluidly connect the auxiliary cabinet 504 to the air conduit 302A upstream of the heat exchanger 170. Accordingly, warm air from the auxiliary cabinet 504 may be mixed with cold air inlet stream in the air conduit 302A, thereby increasing the temperature of air provided to the heat exchanger 170. In particular, the temperature of air flowing through the auxiliary cabinet 504 may be increased by from about 5° C. to about 25° C., such as from about 10° C. to about 15° C., due to heat generated by components in the auxiliary cabinet 504. In addition, since the air output from the auxiliary cabinet 504 is not released from the system 16A, the total amount of ambient air provided to the system 16A via the system blower 208 may be reduced by a corresponding amount. As such, the size of the heat exchanger 170 may be reduced, as compared to the system 16.

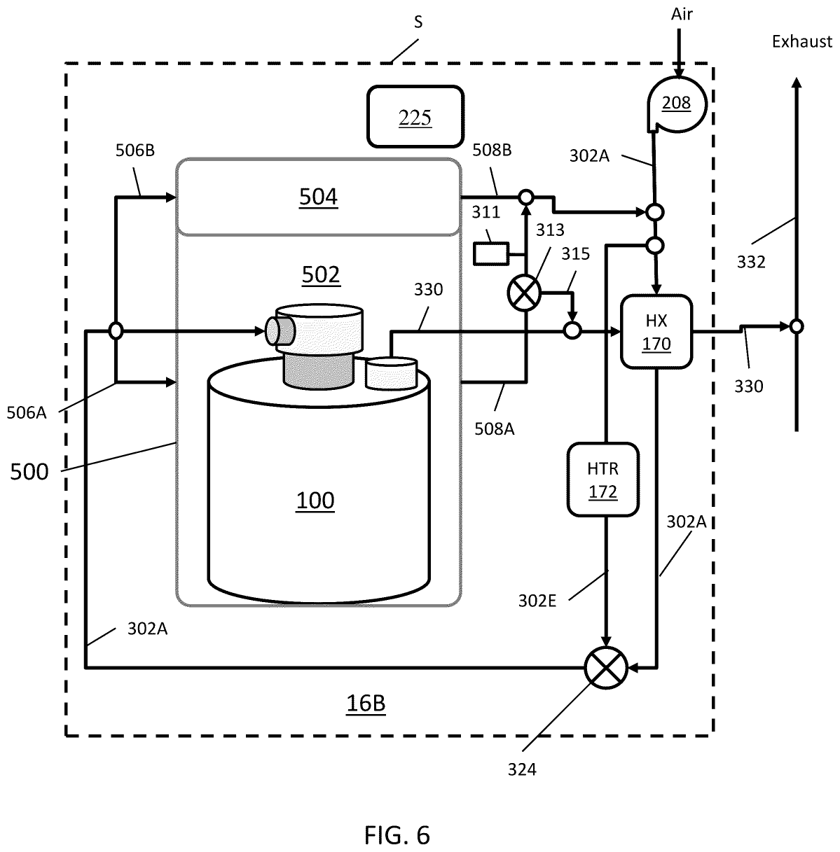

FIG. 6 is a schematic view of a fuel cell system 16B, according to various embodiments of the present disclosure. The system 16B may be similar to system 16A. As such, only the differences therebetween will be discussed in detail.

Referring to FIG. 6, in system 16B, both the air outlet conduit 508A and the air outlet conduit 508B may be fluidly connected to the air conduit 302A. As such, warm air from both the hotbox cabinet 502 and the auxiliary cabinet 504 may be mixed with cold ambient air inlet stream in the air conduit 302A. In addition, since the air output from both the hotbox cabinet 502 and the auxiliary cabinet 504 is not released from the system 16B, the total amount of ambient air provided to system 16B via the system blower 208 may be reduced by a corresponding amount. As such, the size of the heat exchanger 170 may be further reduced, as compared to systems 16 and 16A.

In various embodiments, it may be important to prevent fuel from entering the air conduit 302A which is provided into the fuel cell stacks. For example, if a fuel leak occurs in the hotbox cabinet 502, then the leaked fuel may mix with the hot box air in the hotbox cabinet 502. Such leaked fuel may then be undesirably recycled into to the air conduit 302A via the cabinet air outlet conduits 508A and 508B. In view of this problem, system 16B may include a fuel leak sensor 311, a diversion valve 313, and a diversion conduit 315. In particular, the fuel leak sensor 311 may be configured to detect fuel in the air outlet conduit 508A. The diversion valve 313 may be a three-way valve located at the junction of conduits 508A and 315. The controller 225 may be configured to control the diversion valve 313 located on the diversion conduit 315 based on fuel concentration data received from the fuel leak sensor 311. For example, the controller 225 may be configured to switch diversion valve 313 to open the path from conduit 508A into conduit 315 and to close the path from conduit 508A into conduit 508B, if a fuel concentration above a threshold value (i.e., a fuel leak) is detected by the fuel leak sensor 311. In this case, the fuel-containing cabinet air is diverted from conduit 508A into the diversion conduit 315 and provided to the exhaust conduit 330 rather than being recycled into the air conduit 302A. The controller 225 may also be configured to initiate a system shutdown, if a fuel leak is detected. If the fuel leak sensor 311 does not detect a fuel concentration above the threshold value, then the diversion valve 313 remains in the position which closes the path from conduit 508A into conduit 315, and the cabinet air is recycled from the cabinet air outlet conduit 508A into conduit 302A via auxiliary cabinet air outlet conduit 508B.

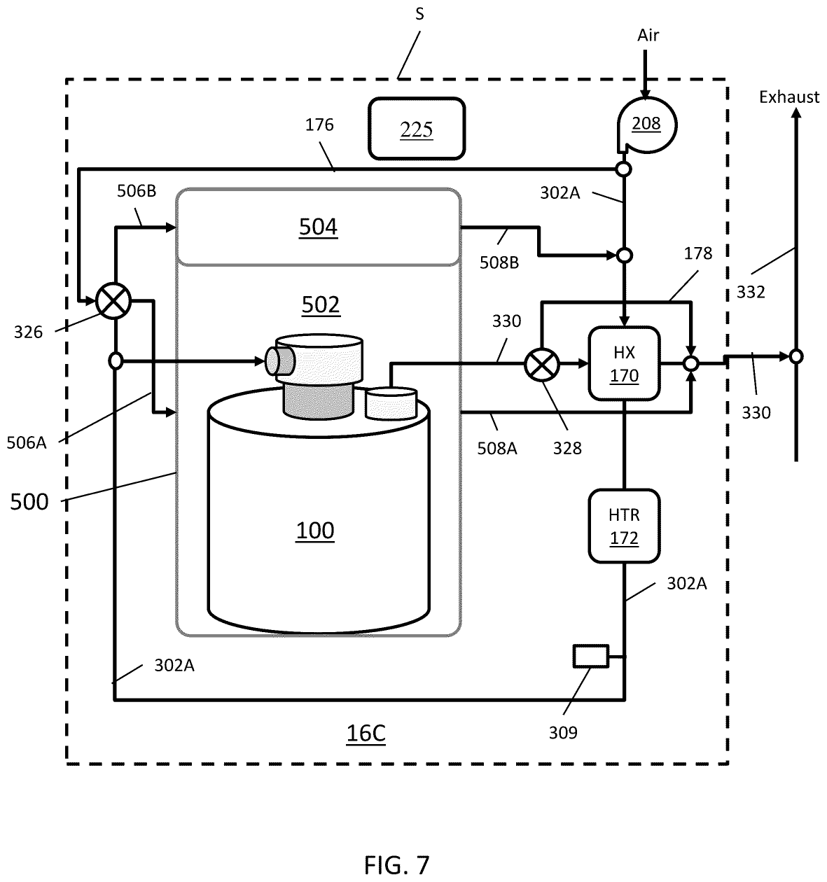

FIG. 7 is a schematic view of a fuel cell system 16C, according to various embodiments of the present disclosure. The system 16C may be similar to system 16. As such, only the differences therebetween will be discussed in detail.

Referring to FIG. 7, in system 16C, the heater 172 and the heat exchanger 170 may be fluidly connected in series by the air conduit 302A. In particular, the heater 172 may be disposed on the air conduit 302A, downstream of the heat exchanger 170, with respect to an air inlet stream flow direction through the air conduit 302A.

The system 16C may include a heat exchanger bypass conduit 178 and a bypass valve 328. The bypass conduit 178 may fluidly connect the cathode exhaust outlet conduit 330 to the system exhaust conduit 332, thereby bypassing the heat exchanger 170. The controller 225 may be configured to control the exhaust valve 328, in order to control the relative amounts of cathode exhaust that flow through the heat exchanger 170 and the bypass conduit 178, and thereby control the temperature of the air in the air conduit 302A. For example, in some embodiments, the controller 225 may be configured to monitor the temperature of the air in the air conduit 302A, downstream of the heat exchanger 170, using temperature sensor 309. Based on the detected temperature, the controller 225 may control the actuation of the bypass valve 328 in real time, in order to control the amount of cathode exhaust flowing through the heat exchanger 170 and the heat exchanger bypass conduit 178 and thereby maintain a desired air temperature in the air conduit 302A.

In some embodiments, the bypass valve 328 may be a variable valve that is configured to divert between 0% and 100% of the cathode exhaust from cathode exhaust outlet conduit 330 into the system exhaust conduit 332, via the bypass exhaust conduit 178, in order to control the heating of the air in the air conduit 302A by the heat exchanger 170. In such embodiments, the controller 225 may be configured to selectively control the bypass valve 328, such that the bypass valve is partially or completely open, to control heating of the air in the heat exchanger 170. In an alternative embodiment, the bypass valve 328 may be an on/off valve. In such embodiments, the controller 225 may pulse the bypass valve 328 open and/or closed, as necessary to control the temperature of the air in the air conduit 302A.

Thus, if the air inlet stream is colder than a desired temperature, then the controller opens the bypass valve 328 to provide all or a larger portion of the cathode exhaust stream into the heat exchanger 170 and/or turns on or raises the temperature of the heater 172. This increases the temperature of the air inlet stream. If the air inlet stream is warmer than a desired temperature, then the controller closes the bypass conduit 328 to provide no cathode exhaust stream or a smaller portion of the cathode exhaust stream into the heat exchanger 170 and/or turns off or lowers the temperature of the heater 172. This decreases the temperature of the air inlet stream.

In system 16C, the air valve 326 may be configured to control air provided from the preheating bypass conduit 176 directly to the air inlet conduit 506A and/or the air inlet conduit 506B. As such, the temperature of air provided to the hotbox cabinet 502 and/or the auxiliary cabinet 504 may be independently controlled by using the controller 225 to control the air valve 326. The air valve 326 may be an on/off valve or a proportional valve.

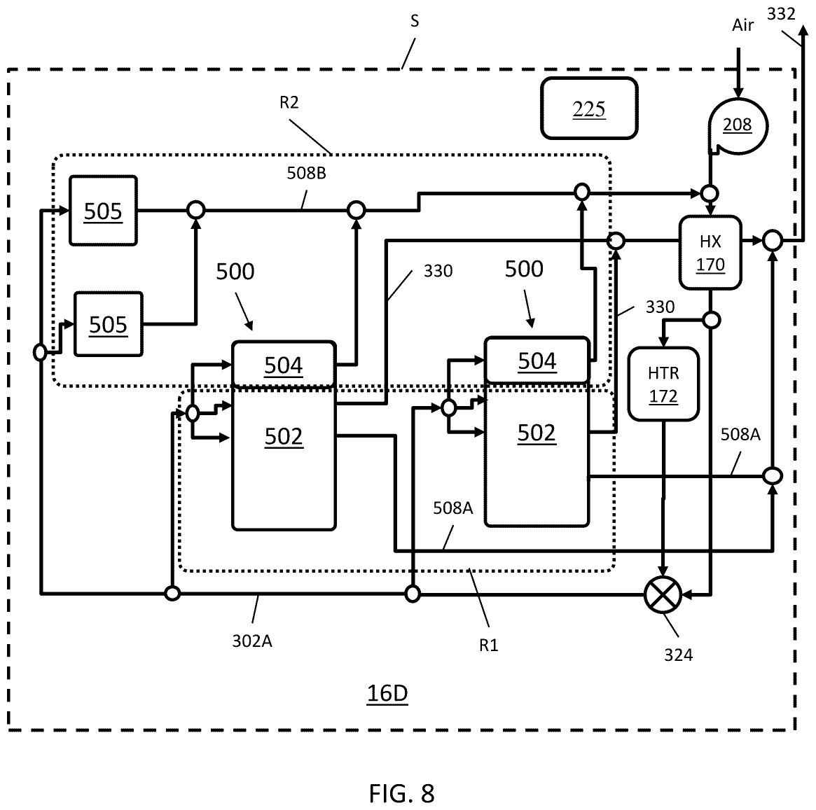

FIG. 8 is a schematic view of a fuel cell system 16D, according to various embodiments of the present disclosure. The system 16D may be similar to systems 16A-16C. As such, only the differences therebetween will be discussed in detail.

Referring to FIG. 8, system 16D includes multiple power module housings 500 and auxiliary modules 505 located in the system enclosure S. The power module housings 500 and auxiliary modules 505 are each fluidly connected to the system blower 208. For example, system 16D may include from 2 to 30 power module housings 500 fluidly connected to the heat exchanger 170 and the system blower 208.

The auxiliary modules 505 may include an inverter module, a fuel processing module, a telemetry module and/or a water distribution module. The auxiliary modules 505 may also be fluidly connected to air conduit 302A, so as to receive preheated air from the heat exchanger 170.

In some embodiments, the fuel cell cabinets 502 may be disposed in a first room R1, and the auxiliary cabinets 504 and/or auxiliary modules 505 may be disposed in a second room R2. The first room R1 may be maintained at a negative pressure and the second room R2 may be maintained at a positive pressure. In some embodiments, all of the air exhaust generated by the elements of the second room R2 may be recycled to the air conduit 302A, upstream of the heat exchanger 170, to preheat the incoming air. All of the air exhaust from the elements in the first room R1 may be provided to the cathode exhaust outlet conduit 330.

In some embodiments, the fuel cell stack exhaust may be provided from all of the hot boxes in respective power module housings 500 into a common cathode exhaust outlet conduit 330 through the respective cathode exhaust outlets 103. The exhaust from the hotbox cabinets 502 is provided into a common cabinet air exhaust conduit 508A. The exhaust from the auxiliary cabinets 504 and/or auxiliary modules 505 is provided into a common auxiliary cabinet air exhaust conduit 508B.

It should be noted that while the cathode exhaust conduit 330 is schematically shown in FIG. 8 as passing through the second room R2, in other embodiments the cathode exhaust conduit 330 does not pass through the second room R2.

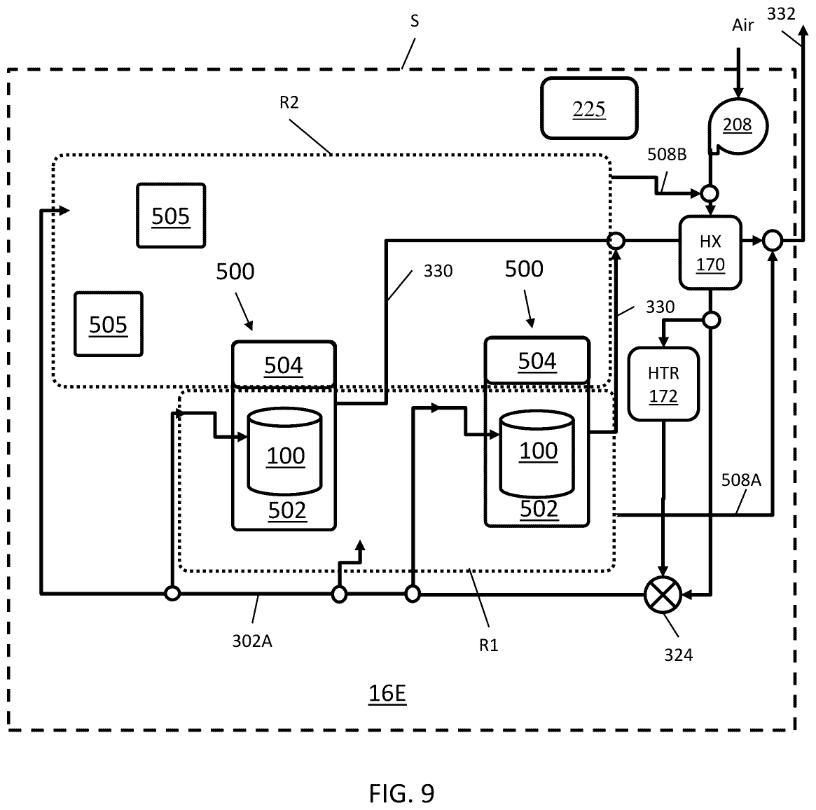

FIG. 9 is a schematic view of a fuel cell system 16E, according to various embodiments of the present disclosure. The system 16E may be similar to system 16D. As such, only the differences therebetween will be discussed in detail.

Referring to FIG. 9, system 16E differs from system 16D in that the air is provided from the air conduit 302A into the first room R1 and the second room R2, instead of directly into the various housings 502, 504 and modules 505. Thus, the air from conduit 302A heats the air in the first room R1 and the second room R2. The heated air in the first room R1 heats the housings 502 located in the first room R1, while the heated air in the second room heats the housings 504 and modules 505 located in the second room R2. The heated air from the first and the second rooms is provided into respective air exhaust conduits 508A and 508B. While the air exhaust conduit 508A is shown as being connected to the cathode exhaust conduit 330 in FIG. 9, in other embodiments, the air exhaust conduit 508A may be fluidly connected to the air conduit 302A as described with respect to FIG. 6 above, to recycle the heated air from the first room R1 into the inlet air in the air conduit 302A.

In some embodiments, cathode exhaust from multiple system enclosures S may be combined and provided to an external heat exchanger, such as a combined heat and power heat exchanger system. In such embodiments, the heat exchangers 170 may optionally be omitted.

According to various embodiments illustrated in FIGS. 4-9, a fuel cell system (16, 16A, 16B, 16C, 16D, 16E) includes a stack 102 of fuel cells, an anode exhaust cooler 140 configured to heat an air inlet stream using heat extracted from an anode exhaust stream output from the stack 102, a first air conduit 302A fluidly connected to an air inlet of the anode exhaust cooler 140 and configured to provide an air inlet stream to the anode exhaust cooler 140, a second air conduit 302B connected to an air outlet of the anode exhaust cooler 140 and configured to receive a heated air inlet stream output from the anode exhaust cooler 140 and to provide the heated air inlet stream into the stack 102 (e.g., directly or via the cathode recuperator 120), a first anode exhaust conduit 308C (e.g., alone or in combination with combination with conduits 308A and 308B) fluidly connecting an anode exhaust outlet of the stack 102 to an anode exhaust inlet of the anode exhaust cooler 140, a second anode exhaust conduit 308 fluidly connecting an anode exhaust outlet of the anode exhaust cooler 140 to a fuel inlet of the stack 102 (e.g., directly or via mixer 210 and fuel conduits 300C and 300D), and at least one component configured to maintain a temperature of an anode exhaust stream exiting the anode exhaust cooler 140 into the second anode exhaust conduit 308E at a temperature above 100° C.

In some embodiments, an anode recycle blower 212 is located on the second anode exhaust stream conduit 308E, and the at least one component is configured to maintain the temperature of the anode exhaust stream exiting the anode exhaust cooler 140 into the second anode exhaust conduit 308E at a temperature between 110° C. and 180° C. to prevent water condensation and damage to the blower 212.

In the embodiments of FIGS. 4-9, the at least one component comprises the heat exchanger 170 fluidly connected to the first air conduit 302A and the cathode exhaust outlet conduit 330 and configured to preheat the air inlet stream in the first air conduit by extracting heat from a cathode exhaust stream output from the stack 102. As noted above, the cathode exhaust conduit 304 is fluidly connected to a cathode exhaust outlet of the stack 102 (e.g., directly or via the cathode recuperator 120).

In the embodiments of FIGS. 4-9, a supplemental heater 172 is fluidly connected in parallel or in series with the heat exchanger 170. The supplemental heater is configured to heat the air inlet stream provided to the first air conduit 302A. The systems 16, 16A, 16B, 16C, 16D and 16E also include a housing 500 comprising a hotbox cabinet 502 and an auxiliary cabinet 504. A hotbox 100 is disposed in the hotbox cabinet 502, and the stack 102 is located in the hotbox 100. Electronic components (e.g., DC/DC converters etc.,) are located in the auxiliary cabinet 504, and a system controller 225 may be located in the system enclosure S, outside of the power module enclosures 500. A hotbox cabinet air inlet conduit 506A fluidly connects the first air conduit 302A to an inlet of the hot box cabinet 502. An auxiliary cabinet air inlet conduit 506B fluidly connects the first air conduit 302A to an inlet of the auxiliary cabinet 502. The systems 16, 16A, 16B, 16C, 16E may also include a hotbox cabinet air outlet conduit 508A fluidly connecting an outlet of the hotbox cabinet 502 to the first air conduit 302A, an auxiliary cabinet air outlet conduit 508B fluidly connecting an outlet of the auxiliary cabinet to the first air conduit 302A, and/or a preheating bypass conduit 176 which bypasses the heat exchanger 170 and fluidly connects the first air conduit 302A to the hotbox and auxiliary cabinet air inlet conduits (506A, 506B).

In the embodiments of FIGS. 4-9, a method of operating a fuel cell system (16, 16A, 16B, 16C, 16D, 16E) includes providing an anode exhaust stream from a stack 102 of fuel cells into an anode exhaust cooler 140, providing an air inlet stream 412 into the anode exhaust cooler 140 and heating the air inlet stream using heat extracted from the anode exhaust stream, providing a heated air inlet stream output from the anode exhaust cooler 140 into the stack 102, providing a cooled anode exhaust stream at a temperature between 110° C. and 180° C. from the anode exhaust cooler 140 into an anode recycle blower 212, and recycling at least a portion of the cooled anode exhaust stream into a fuel inlet stream provided into the stack 102.

In one embodiment, the fuel cell system (16, 16A, 16B, 16C, 16D, 16E) is operated in an air temperature of less than negative 20° C., such as between negative 21° C. and negative 40° C.

In the embodiments of FIGS. 4-9, at least a portion of the air inlet stream is provided into a heat exchanger 170 upstream of the anode exhaust cooler 140, and at least a portion of a cathode exhaust stream is provided from the stack 102 into the heat exchanger 170 to heat the air inlet stream in order to provide the cooled anode exhaust stream at the temperature between 110° C. and 180° C. from the anode exhaust cooler 140 into the anode recycle blower 212.

In the embodiments of FIGS. 4-9, at least a portion of the air inlet stream is heated in a heater 172 located fluidly in parallel or in series with the heat exchanger 170. In some embodiments, at least a first portion of the heated air inlet stream is provided to a hotbox 100 disposed in a hotbox cabinet 502, and at least a second portion of the heated air inlet stream is provided to electronic components located in an auxiliary cabinet 504. In some embodiments, the heated air inlet stream is provided from the hotbox cabinet 502 into the air inlet stream 412, the heated air inlet stream is provided from the auxiliary cabinet 504 into the air inlet stream 412, and/or a portion of the air inlet stream 412 which bypasses the heat exchanger 170 is provided to the hotbox cabinet 502 the auxiliary cabinet 504.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a power module housing comprising a hotbox cabinet and an auxiliary cabinet;
a hotbox disposed in the hotbox cabinet and comprising a stack of fuel cells;
electronic components disposed in the auxiliary cabinet;
a system blower configured to provide air into the power module housing;
a hotbox air inlet conduit fluidly connecting the system blower to the hotbox;
a heat exchanger configured to preheat air in the hotbox air inlet conduit by extracting heat from cathode exhaust output from the hotbox; and
a cathode exhaust outlet conduit fluidly connecting a cathode exhaust outlet of the hotbox to the heat exchanger.

2. The fuel cell system of claim 1, further comprising a supplemental heater configured to preheat air in the hotbox air inlet conduit.

3. The fuel cell system of claim 2, wherein the hotbox air inlet conduit fluidly connects the supplemental heater and the heat exchanger in series.

4. The fuel cell system of claim 1, further comprising:
a heater conduit fluidly connected to the hotbox air inlet conduit and configured to bypass the heat exchanger; and
a supplemental heater configured to preheat air in the heater conduit.

5. The fuel cell system of claim 4, further comprising a heater valve configured to control air flow through the heater conduit.

6. The fuel cell system of claim 5, further comprising a temperature sensor configured to detect a temperature of air in the hotbox air inlet conduit, wherein the heater valve is controlled based on the detected temperature.

7. The fuel cell system of claim 1, further comprising:
a preheating bypass conduit fluidly connected to the hotbox air inlet conduit and configured to bypass the heat exchanger; and
an air valve configured to control air flow through the preheating bypass conduit.

8. The fuel cell system of claim 1, further comprising a hotbox cabinet air outlet conduit fluidly connecting an outlet of the hotbox cabinet to the cathode exhaust outlet conduit downstream of the heat exchanger with respect to a flow direction of cathode exhaust through the cathode exhaust outlet conduit.

9. The fuel cell system of claim 8, further comprising an auxiliary cabinet air outlet conduit fluidly connecting an outlet of the auxiliary cabinet to the cathode outlet exhaust conduit downstream of the heat exchanger with respect to the flow direction of cathode exhaust.

10. The fuel cell system of claim 8, further comprising an auxiliary cabinet air outlet conduit fluidly connecting an outlet of the auxiliary cabinet to the hotbox air inlet conduit upstream of the heat exchanger with respect to an air flow direction through the hotbox air inlet conduit.

11. The fuel cell system of claim 1, further comprising:
an auxiliary cabinet air outlet conduit fluidly connecting an outlet of the auxiliary cabinet to the hotbox air inlet conduit upstream of the heat exchanger with respect to an air flow direction through the hotbox air inlet conduit; and
a hotbox cabinet air outlet conduit fluidly connecting an outlet of the hotbox cabinet to the auxiliary cabinet air outlet conduit.

12. The fuel cell system of claim 1, further comprising a hotbox cabinet air inlet conduit fluidly connecting the hotbox air inlet conduit to an inlet of the hotbox cabinet.

13. The fuel cell system of claim 12, further comprising an auxiliary cabinet air inlet conduit fluidly connecting the hotbox air inlet conduit to an inlet of the auxiliary cabinet.

14. The fuel cell system of claim 13, further comprising a preheating bypass conduit fluidly connecting the hotbox air inlet conduit to the auxiliary cabinet air inlet conduit and the hotbox cabinet inlet conduit, wherein the preheating bypass conduit bypasses the heat exchanger.

15. The fuel cell system of claim 14, further comprising a bypass valve configured to control air flow through the hotbox cabinet air inlet conduit, the auxiliary cabinet air inlet conduit, and the preheating bypass conduit.

16. The fuel cell system of claim 15, wherein the bypass valve is further configured to control air flow from the hotbox air inlet conduit to the hotbox cabinet air inlet conduit and the auxiliary cabinet air inlet conduit.

17. The fuel cell system of claim 1, wherein the heat exchanger is configured to preheat air provided to multiple power module housings by extracting heat from cathode exhaust received from the multiple power module housings.

18. The fuel cell system of claim 17, wherein the cathode exhaust outlet conduit is fluidly connected to a system exhaust conduit configured to receive cathode exhaust from the multiple power module housings.

19. A fuel cell system, comprising:
a power module housing comprising a hotbox cabinet and an auxiliary cabinet;
a hotbox disposed in the hotbox cabinet and comprising a stack of fuel cells;
electronic components disposed in the auxiliary cabinet;
a system blower configured to provide air into the power module housing;
a hotbox air inlet conduit fluidly connecting the system blower to the hotbox;
a heat exchanger configured to preheat air in the hotbox air inlet conduit by extracting heat from cathode exhaust output from the hotbox;
a cathode exhaust outlet conduit fluidly connecting a cathode exhaust outlet of the hotbox to the heat exchanger;
a supplemental heater configured to preheat air in the hotbox air inlet conduit; and
a bypass conduit fluidly connected to the hotbox air inlet conduit, wherein the bypass conduit bypasses the heat exchanger and the auxiliary heater.

20. The fuel cell system of claim 19, further comprising:
a hotbox cabinet air outlet conduit fluidly connecting an outlet of the hotbox cabinet to the cathode exhaust outlet conduit downstream of the heat exchanger; and
an auxiliary cabinet air outlet conduit fluidly connecting an outlet of the auxiliary cabinet to the cathode exhaust outlet conduit downstream of the heat exchanger.
